(19) United States
(12) Patent Application Publication
(10) Pub. No.: US 2015/0294758 A1
(43) Pub. Date: Oct. 15, 2015

(54) Insulated Wire

(71) Applicant: Yazaki Corporation, Tokyo (JP)

(72) Inventors: Taketo Kumada, Susono-shi (JP); Kazuhiro Ohgushi, Susono-shi (JP)

(73) Assignee: Yazaki Corporation, Tokyo (JP)

(21) Appl. No.: 14/751,440

(22) Filed: Jun. 26, 2015

Related U.S. Application Data
(63) Continuation of application No. PCT/JP2013/083461, filed on Dec. 13, 2013.

(30) Foreign Application Priority Data
Dec. 26, 2012 (JP) 2012-283148

(51) Int. Cl. H01B 7/00; C22C 9/00; C22C 9/06; H01B 1/02

(52) U.S. Cl. CPC H01B 7/0009; H01B 1/026; C22C 9/00; C22C 9/06

(57) ABSTRACT

An insulated wire 1 includes a stranded conductor 11 composed of a plurality of metal conductor strands 11a twisted together, covered with an electrically insulative insulator 12, each metal conductor strand 11a being made of a copper alloy having a tensile strength of 500 MPa or higher and an elongation of 6% or greater, and having a strand diameter of 0.12 mm or smaller.

### CROSS REFERENCE TO RELATED APPLICATIONS

This application is a continuation of International Patent Application No. PCT/JP2013/083461 filed on Dec. 13, 2013, claiming priority from Japanese Patent Application No. 2012-283148 filed on Dec. 26, 2012, the contents of which are incorporated herein by reference.

### FIELD OF INVENTION

The present invention relates to an insulated wire.

### BACKGROUND ART

Conventionally, machines such as robots have movable parts that perform complicated movements. Accordingly, electrical wires for use in such machines are hence required to be suitable for the movable parts. Such movable parts are configured such that, for example, a bending radius is designed to be large so as to reduce bending strain. For such movable parts, insulated wires having a metal conductor with excellent high-cycle fatigue properties are used. It is known to be advantageous that the metal conductor have high tensile strength (physical property value [MPa]) in locations where the bending strain is small and high flexing fatigue cycles are necessary (that is, high-cycle regions).

To improve the high-flexing fatigue properties of insulated wires, it is proposed to reduce a diameter of strands used in the metal conductor (see Patent Document 1 or 2). According to these documents, by reducing the diameter of strands of the metal conductor, the strain to be caused in the metal conductor can be reduced and the tensile strength of the metal conductor can be improved. Namely, according to these techniques, an electrical wire adapted to a high-cycle region can be provided by reducing the bending strain inside metal conductor strands with the same bending radius of the insulated-wire.

Patent Document 1: JP 2010-18848 A

Patent Document 2: JP 2001-93341 A

However, the insulated wire described in patent document 1 or 2 may be applicable only in a high-cycle region and may not be suitable for a low-cycle region. For example, in machines such as robots, the bending radius needs to be designed in accordance with the flexing fatigue properties of the insulated wire to be used, and the bending portion may need to be enlarged in accordance with the resistible number of flexing actions required by the machines. In addition, because the insulated wire may be bent at a small radius in a limited space during assembly and insertion and pulling-out of connectors may be repeated, the insulated wire has a portion in which a bending strain is increased. In such cases where it is necessary to repeat the bending of the insulated wire at a small bending radius so that a bending strain of the insulated wire is increased, it is necessary to employ an insulated wire suitable for low-cycle regions. If an insulated wire suitable only for high-cycle regions is used in such cases where an increased bending strain is imposed on the insulated wire, the electrical wire may not withstand the bending strain, and may cause conductor damage or the like.

### SUMMARY OF INVENTION

The present invention has been made in view of the circumstances described above, and it is an object thereof to provide an insulated wire that is applicable in both a high-cycle region and a low-cycle region.

To the above object, an insulated wire according to the present invention has features as described in (1) below.
(1) An insulated wire including an electrically conductive metal conductor strand or a stranded conductor composed of a plurality of metal conductor strands twisted together, the metal conductor strand or the stranded conductor being covered with an electrically insulative insulator, wherein the metal conductor strands each are made of a copper alloy having a tensile strength of 500 MPa or higher and an elongation of 6% or greater and have a strand diameter of 0.12 mm or smaller.

According to this insulated wire, a copper alloy having a tensile strength of 500 MPa or higher and an elongation of 6% or greater is used as the metal conductor and the strand diameter is 0.12 mm or less. Owing to this, it is possible to resist about 5,000,000 flexing actions at a large bending radius of, for example, R=20 mm or greater, so that it is applicable in a high-cycle region where the bending strain is small and high flexing fatigue cycles are required. Furthermore, since the metal conductor has an elongation of 6% or greater, it is applicable also in a low-cycle region where the bending strain is large. Consequently, it is possible to provide an insulated wire capable of satisfying the numbers of flexing actions required to resist in the high-cycle region and in the low-cycle region respectively.

### BRIEF DESCRIPTION OF THE DRAWINGS

FIG. 1 is a cross-sectional view illustrating an example of an insulated wire according to an embodiment.

FIG. 2 is a graph showing relationships between tensile strength and elongation.

FIG. 3 is a graph showing tensile strength and elongation that vary depending on aging temperature.

FIG. 4 (a) and FIG. 4 (b) are table charts showing the configurations of insulated wires according to Examples and Comparative Examples which were subjected to a flexing resistance test, and also showing the results of the test.

### EMBODIMENTS OF INVENTION

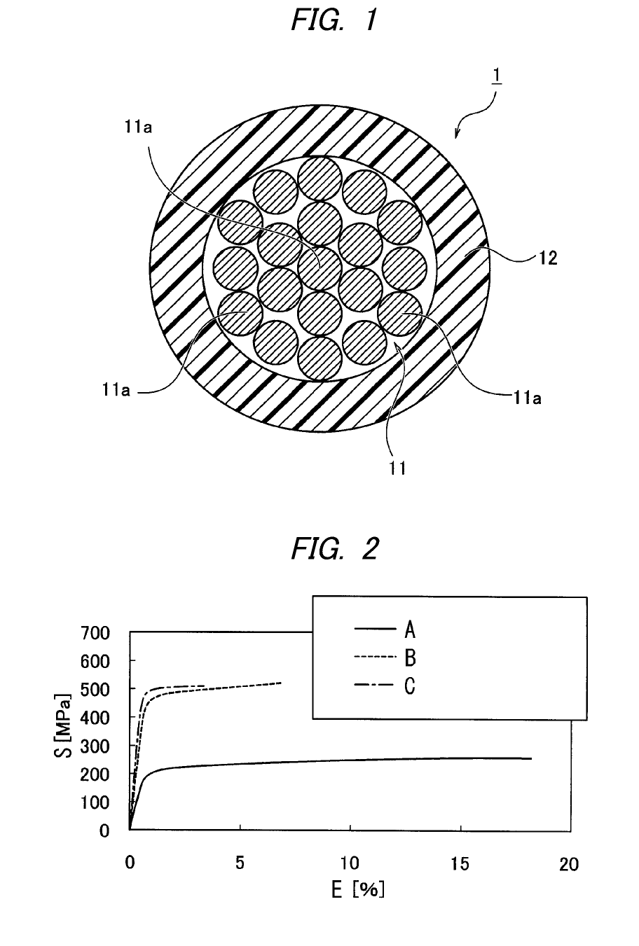

Hereinafter, preferred embodiments of the present invention will be described with reference to the drawings. FIG. 1 is a diagram illustrating an example of an insulated wire according to an embodiment of the present invention.

The insulated wire 1 according to this embodiment has, as shown in FIG. 1, a stranded conductor 11 covered with an electrically insulative insulator 12. The stranded conductor 11 is composed of a plurality (nineteen in the example shown in FIG. 1) of metal conductor strands 11a twisted together, and the cross-sectional area is, for example, 0.08 sq (AWG28). In this embodiment, the metal conductor strands 11a are made of a copper alloy, more specifically, a precipitation-hardenable copper alloy such as Cu—Cr, Cu—Cr—Zr, Cu—Cr—Zn, Cu—Co—P, Cu—Ni—P, and Cu—Fe—P alloys. The stranded conductor 11 may be composed of only one metal conductor strand 11a in an untwisted manner. Also, the stranded conductor 11 is not limited to the one composed of nineteen metal conductor strands 11a twisted together. For example, the stranded conductor 11 may be composed of thirty metal conductor strands 11a twisted together so as to have a cross-sectional area of 0.13 sq (AWG26), or may be composed of different number of metal conductor strands 11a twisted together. The insulator 12 is a polyvinyl chloride resin composition (or a polyolefin resin composition) in the example shown in FIG. 1. However, the insulator 12 is not limited thereto.

In the metal conductor strand 11a, the combination ratios of respective metals are as follows. When the metal conductor strand 11a is a Cu—Cr—Zr copper alloy, the alloy includes 0.50 to 1.50% by mass of Cr, 0.05 to 0.15% by mass Zr, and 0.10 to 0.20% by mass of Sn, the remainder being Cu. When the stranded conductor 11 is a Cu—Co—P copper alloy, the alloy includes 0.20 to 0.30% by mass of Co, 0.07 to 0.12% by mass of P, 0.02 to 0.05% by mass of Ni, 0.08 to 0.12% by mass of Sn, and 0.01 to 0.04% by mass of Zn, the remainder being Cu.

The insulated wire 1 according to this embodiment is applicable in both a high-cycle region and a low-cycle region. Specifically, the insulated wire 1 according to this embodiment is capable of performing 5,000,000 flexing actions or more at a bending radius of R=20 mm or greater that involves a small bending strain (that is, applicable in a high-cycle region), and is capable of performing several tens of flexing actions or more at a bending radius of R=0.5 mm that involves a large bending strain (that is, applicable in a low-cycle region). Detailed description will be given below.

First, for providing an insulated wire which is applicable in a high-cycle region, a high tensile strength is advantageous to the metal conductor 11. In this embodiment, by using the metal conductor 11 described above, a tensile strength of 500 MPa or higher can be attained to render the insulated wire applicable in a high-cycle region.

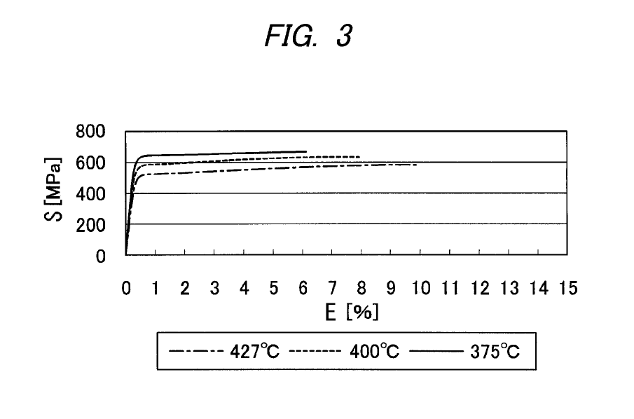

FIG. 2 is a graph which shows relationships between tensile strength and elongation. In FIG. 2, symbol S for the ordinate indicates tensile strength [MPa] and symbol E for the abscissa indicates elongation [%].

As shown in FIG. 2, the tensile strength of soft copper denoted by symbol A varies in accordance with elongation but is approximately a little over 200 MPa. In contrast, the tensile strength of a copper alloy used in industrial robot cables, denoted by symbol C, and the tensile strength of the precipitation-hardenable copper alloy described above, denoted by symbol B, both vary in accordance with elongation and have a region where the tensile strength is 500 MPa or higher. Therefore, the copper alloy used in industrial robot cables and the precipitation-hardenable copper alloy are applicable in a high-cycle region.

For providing an insulated wire applicable in a low-cycle region, it is advantageous that the metal conductor 11 have a high elongation percentage. In this embodiment, by using the metal conductor 11 described above, an elongation of 6% or greater can be achieved so that it is applicable in a low-cycle region.

As shown in FIG. 2, the copper alloy used in industrial robot cables, denoted by symbol C, has an elongation of about 3% at the maximum. That is, it cannot achieve an elongation of 6% or greater so that it is not applicable in a low-cycle region. In contrast, the metal conductor 11 described above can achieve an elongation of 6% or greater so that it is applicable in a low-cycle region. The tensile strength is determined from a test force N measured with a tensile tester as provided for in JIS-Z-2241 (Methods for Tensile Tests of Metallic Materials), and the elongation is determined from the distance between marked points measured with an extensometer as provided for therein.

For use in a high-cycle region, high flexing properties are required at a bending radius of R=20 mm or greater that involves a small bending strain. That is, in this embodiment, it is necessary to set the diameter of each metal conductor strand 11a such that high flexing properties are satisfied with a bending radius of R=20 mm. As a result of diligent studies, the inventors have found that, in view of the tendency that the strain of metal conductor strands 11a becomes smaller as the diameter thereof decreases, the strand diameter needs to be 0.12 mm or smaller in order for the copper alloy forming the metal conductor 11 to satisfy high flexing properties at a bending radius of R=20 mm. Owing to this, it is possible to resist about 5,000,000 flexing actions at a large bending radius of R=20 mm or greater.

As described above, in the metal conductor 11 according to this embodiment, a copper alloy having a tensile strength of 500 MPa or higher and an elongation of 6% or greater is used, and the strand diameter is 0.12 mm or smaller.

It is desirable that the metal conductor 11 have an elongation less than 15%, besides satisfying the conditions described above. There is a correlation between the elongation and the tensile strength, and a change in elongation results in a change in tensile strength. Because of this, copper-based precipitation-hardenable alloys having an electrical conductivity of 65% IACS (International Annealed Copper Standard) or higher cannot maintain the tensile strength of 500 MPa when the elongation is 15% or higher. Furthermore, it is desirable that the tensile strength thereof be less than 650 MPa. This is because copper based alloys cannot maintain an elongation of 6% when the tensile strength is 650 MPa or higher.

It is also desirable that the diameter of each metal conductor strand 11a be 0.05 mm or larger. This is because, without the diameter of at least 0.05 mm, drawing becomes difficult due to the accumulation of drawing strain. To have a diameter smaller than that, it is necessary to conduct a solution heat treatment during the drawing to release the accumulated strain. However, it is not easy to give a solution heat treatment to wires of 1 mm or thinner.

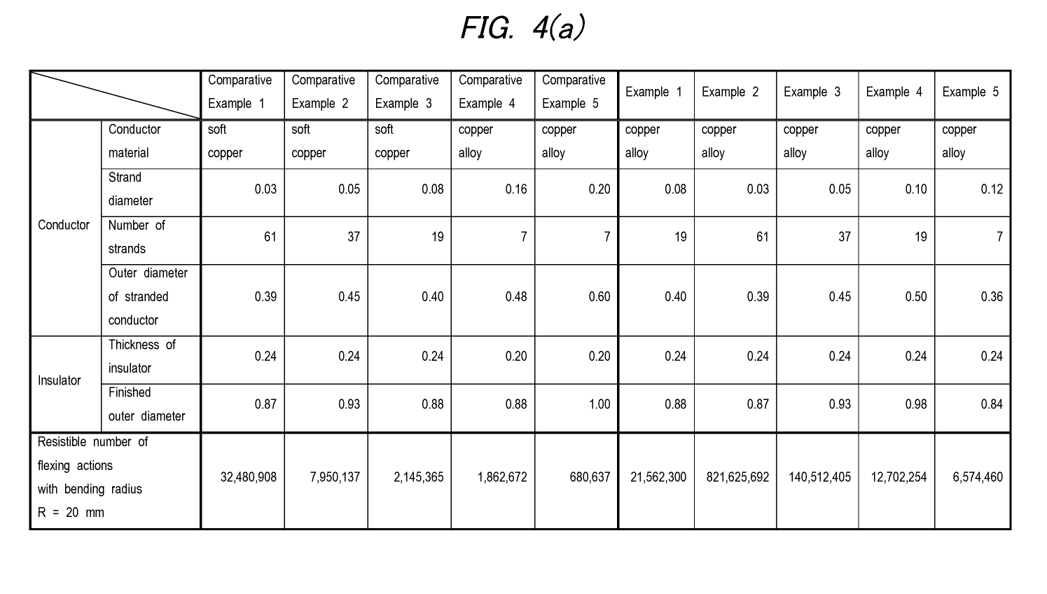

The tensile strength and the elongation are adjustable to some degree, by changing the temperature at which the conductor material is aging-treated. FIG. 3 is a graph showing tensile strength and elongation that vary depending on aging temperature. In FIG. 3, symbol S for the ordinate indicates the tensile strength [MPa] and symbol E for the abscissa indicates the elongation [%].

As shown in FIG. 3, by lowering the aging temperature, the tensile strength of the copper alloy according to this embodiment becomes higher. In contrast, by lowering the aging temperature, the elongation of the copper alloy according to this embodiment tends to become smaller. It is therefore possible to produce a copper alloy having suitable properties, by changing the aging temperature.

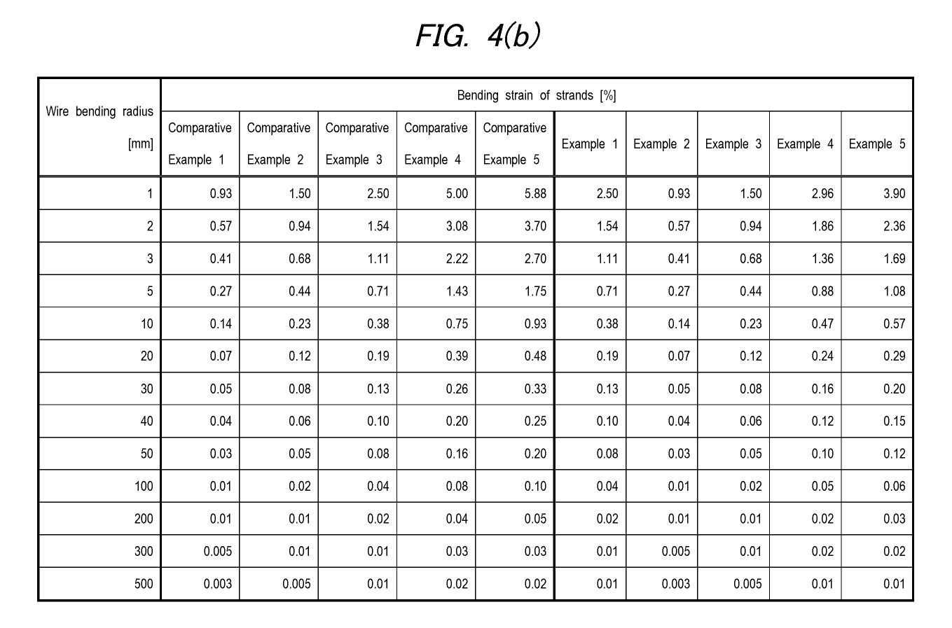

Next, the results of a flexing resistance test of insulated wires 1 according to this embodiment will be described. FIG. 4 (a) and FIG. 4 (b) are table charts showing the configurations of insulated wires according to Examples and Comparative Examples which were subjected to a flexing resistance test, and also showing the results of the test.

First, the diameter of the metal conductor strand in Example 1 was 0.08 mm as shown in FIG. 4 (a) and FIG. 4 (b). As a copper alloy, a Cu—Co—P copper alloy was used. Specifically, the Cu—Co—P copper alloy included 0.20 to 0.30% by mass of Co, 0.07 to 0.12% by mass of P, 0.02 to 0.05% by mass of Ni, 0.08 to 0.12% by mass Sn, and 0.01 to 0.04% by mass of Zn, the remainder being Cu.

The number of metal conductor strands in Example 1 was 19, and the conductor composed of nineteen twisted strands had an outer diameter of 0.40 mm. In Example 1, PVC (polyvinyl chloride) having a thickness of 0.24 mm was used as an insulator. The finished outer diameter of the insulator was 0.88 mm.

In Example 2, the diameter of the metal conductor strand was 0.03 mm. As a copper alloy, the same copper alloy as in Example 1 was used. The number of metal conductor strands in Example 2 was 61, and the conductor composed of sixty-one twisted strands had an outer diameter of 0.39 mm. In Example 2, PVC (polyvinyl chloride) having a thickness of 0.24 mm was used as an insulator. The finished outer diameter of the insulator was 0.87 mm.

In Example 3, the diameter of the metal conductor strand was 0.05 mm. As a copper alloy, the same copper alloy as in Example 1 was used. The number of metal conductor strands in Example 3 was 37, and the conductor composed of thirty-seven twisted strands had an outer diameter of 0.45 mm. In Example 3, PVC (polyvinyl chloride) having a thickness of 0.24 mm was used as an insulator. The finished outer diameter of the insulator was 0.93 mm.

In Example 4, the diameter of the metal conductor strand was 0.10 mm. As a copper alloy, the same copper alloy as in Example 1 was used. The number of metal conductor strands in Example 4 was 19, and the conductor composed of nineteen twisted strands had an outer diameter of 0.50 mm. In Example 4, PVC (polyvinyl chloride) having a thickness of 0.24 mm was used as an insulator. The finished outer diameter of the insulator was 0.98 mm.

In Example 5, the diameter of the metal conductor strand was 0.12 mm. As a copper alloy, the same copper alloy as in Example 1 was used. The number of metal conductor strands in Example 5 was 7, and the conductor composed of seven twisted strands had an outer diameter of 0.36 mm. In Example 5, PVC (polyvinyl chloride) having a thickness of 0.24 mm was used as an insulator. The finished outer diameter of the insulator was 0.84 mm.

In Comparative Example 1, the diameter of the metal conductor strand was 0.03 mm, and soft copper was used as the material thereof. The number of metal conductor strands in Comparative Example 1 was 61, and the conductor composed of sixty-one twisted strands had an outer diameter of 0.39 mm. In Comparative Example 1, PVC (polyvinyl chloride) having a thickness of 0.24 mm was used as an insulator. The finished outer diameter of the insulator was 0.87 mm.

In Comparative Example 2, the diameter of the metal conductor strand was 0.05 mm, and soft copper was used as the material thereof. The number of metal conductor strands in Comparative Example 2 was 37, and the conductor composed of thirty-seven twisted strands had an outer diameter of 0.45 mm. In Comparative Example 2, PVC (polyvinyl chloride) having a thickness of 0.24 mm was used as an insulator. The finished outer diameter of the insulator was 0.93 mm.

In Comparative Example 3, the diameter of the metal conductor strand was 0.08 mm, and soft copper was used as the material thereof. The number of metal conductor strands in Comparative Example 3 was 19, and the conductor composed of nineteen twisted strands had an outer diameter of 0.40 mm. In Comparative Example 3, PVC (polyvinyl chloride) having a thickness of 0.24 mm was used as an insulator. The finished outer diameter of the insulator was 0.88 mm.

In Comparative Example 4, the diameter of the metal conductor strand was 0.16 mm, and the same copper alloy as in Example 1 was used as the material. The number of metal conductor strands in Comparative Example 4 was 7, and the conductor composed of seven twisted strands had an outer diameter of 0.48 mm. In Comparative Example 4, PVC (polyvinyl chloride) having a thickness of 0.20 mm was used as an insulator. The finished outer diameter of the insulator was 0.88 mm.

In Comparative Example 5, the diameter of the metal conductor strand was 0.20 mm, and the same copper alloy as in Example 1 was used as the material. The number of metal conductor strands in Comparative Example 5 was 7, and the conductor composed of seven twisted strands had an outer diameter of 0.60 mm. In Comparative Example 5, PVC (polyvinyl chloride) having a thickness of 0.20 mm was used as an insulator. The finished outer diameter of the insulator was 1.00 mm.

The results of the flexing resistance test conducted with respect to Examples 1 to 5 and Comparative Examples 1 to 5 above were as shown in FIG. 4. In the flexing resistance test, an insulated wire having a given length was bent from a straight state in one direction along a mandrel having a bending radius of 20 mm and was then returned to the straight state, and this bending and straightening operation as one action was repeated. The number of flexing actions which resulted in breakage of the metal conductor strands was counted.

As shown in FIG. 4 (a) and FIG. 4 (b), the number of flexing actions of the insulated wire according to Example 1 reached 21,562,300. The numbers of flexing actions of the insulated wires according to Examples 2 to 5 were 821,625,692, 140,512,405, 12,702,254, and 6,574,460, respectively.

In contrast, the numbers of flexing actions of the insulated wires according to Comparative Examples 1 to 5 were 32,480,908, 7,950,137, 2,145,365, 1,862,672, and 680,637, respectively.

As shown above, the number of flexing actions in each of Examples 1 to 5 exceeded 5,000,000, so that they were found to be suitable for a high-cycle region. Furthermore, since the conductors of the insulated wires according to the Examples have an elongation of 6% or greater, these insulated wires are suitable also for a low-cycle region.

On the other hand, with respect to each of Comparative Examples 3 to 5, the number of flexing actions was less than 5,000,000, so that they were found to be unsuitable for a high-cycle region. With respect to Comparative Examples 1 and 2, the numbers of flexing actions exceeded 5,000,000. However, the results of the experiment show that the strand diameters are limited to 0.05 mm or less and the insulated wires of the Comparative Examples have a problem in that the metal conductor strands are limited to ultrafine strands. Furthermore, comparisons between insulated wires having the same strand diameter (a comparison between Comparative Example 1 and Example 2 and a comparison between Comparative Example 2 and Example 3) revealed that the Comparative Examples were far inferior in the number of flexing actions to Examples 2 and 3.

As described above, according to the insulated wire 1 according to this embodiment, a copper alloy having a tensile strength of 500 MPa or higher and an elongation of 6% or greater is used as the metal conductor 11, and the single-stand diameter is 0.12 mm or less. Owing to this, it is possible to resist about 5,000,000 flexing actions having a large curvature radius of, for example, R=20 mm or greater, so that it is applicable in a high-cycle region where the bending strain is small and high flexing fatigue cycles are required. Furthermore, since the metal conductor has an elongation of 6% or greater, the insulated wire is applicable also in a low-cycle region where the bending strain is large. Consequently, it is possible to provide an insulated wire 1 capable of satisfying the numbers of flexing actions required to resist in a high-cycle region and in a low-cycle region respectively.

While the present invention has been described above based on embodiments thereof, the present invention is not limited to the embodiments described above, and changes may be made therein without departing from the idea of the present invention.

Below is a summary of the insulated wire according to this embodiment.
(1) The insulated wire 1 according to the embodiment is an insulated wire including an electrically conductive metal conductor strand 11a or a stranded conductor 11 composed of a plurality of metal conductor strands 11a twisted together, the metal conductor strand 11a or the stranded conductor 11 being covered with an electrically insulative insulator 12, wherein each metal conductor strand 11a is made of a copper alloy having a tensile strength of 500 MPa or higher and an elongation of 6% or greater, and has a strand diameter of 0.12 mm or smaller.

The insulted wire according to the invention is useful in that this insulated wire can be provided so as to be applicable in a high-cycle region and in a low-cycle region.

What is claimed is:

1. An insulated wire comprising an electrically conductive metal conductor strand or a stranded conductor composed of a plurality of metal conductor strands twisted together, the metal conductor strand or the stranded conductor being covered with an electrically insulative insulator,
wherein the metal conductor strand has a strand diameter of 0.12 mm or smaller, and
wherein the metal conductor strand is made of a precipitation-hardenable copper alloy, the precipitation-hardenable copper alloy being aging-treated to have a tensile strength of 500 MPa or higher and an elongation of 6% or greater.

2. The insulated wire according to claim 1, wherein the precipitation-hardenable copper alloy is a Cu—Cr—Zr copper alloy comprising 0.50 to 1.50% by mass of Cr, 0.05 to 0.15% by mass Zr, and 0.10 to 0.20% by mass of Sn, the remainder being Cu.

3. The insulated wire according to claim 1, wherein the precipitation-hardenable copper alloy is a Cu—Co—P copper alloy comprising 0.20 to 0.30% by mass of Co, 0.07 to 0.12% by mass of P, 0.02 to 0.05% by mass of Ni, 0.08 to 0.12% by mass of Sn, and 0.01 to 0.04% by mass of Zn, the remainder being Cu.
